(19) United States
(12) Patent Application Publication
(10) Pub. No.: US 2018/0304283 A1
(43) Pub. Date: Oct. 25, 2018

(54) ELECTROSTATIC SPRAY DEVICE

(71) Applicant: ANEST IWATA Corporation, Kanagawa (JP)

(72) Inventors: Kazuaki SATO, Kanagawa (JP); Shoji KAKIZAKI, Kanagawa (JP)

(21) Appl. No.: 15/774,739

(22) PCT Filed: Nov. 9, 2016
(86) PCT No.: PCT/JP2016/083185

§ 371 Date: May 9, 2018

(30) Foreign Application Priority Data
Nov. 9, 2015 (JP) 2015-219609

(51) Int. Cl. B05B 5/04

(52) U.S. Cl. CPC B05B 5/0407

(57) ABSTRACT

An electrostatic spray device including a voltage applicator and an isoelectric line adjustment electrode. The voltage applicator applies a voltage between a liquid sprayer and a heteropolar portion functioning as a pole opposite from a pole of the liquid sprayer to generate an electrostatic force. The isoelectric line adjustment electrode is made from a conductive material and adjusts equipotential curves appearing so as to surround the nozzle. The isoelectric line adjustment electrode obtains the equipotential curves at least partially drawing curvature gentler than curves of equipotential curves appearing near a front side of the nozzle in a state where the isoelectric line adjustment electrode is not disposed. The isoelectric line adjustment electrode is located near an outer periphery at a distal end of the nozzle and has an electric potential identical to an electric potential of the liquid sprayer such that the equipotential curves drawing the gentle curvature are obtained.

### TECHNICAL FIELD

The present invention relates to an electrostatic spray device.

### BACKGROUND ART

There has been known an electrostatic spray device (see PTL 1). With this electrostatic spray device, by an application of a high voltage between a nozzle and a counter electrode, ions in liquid gather together near a surface of the liquid at a distal end of the nozzle by a strong electric field caused by the high voltage, and the ions in the liquid are attracted to an object on the counter electrode by the force of the electric field. Consequently, a taylor cone where the liquid surface projects into a conical shape with the apex facing the object is formed. Then, fine droplets are torn off from the taylor cone and sprayed by Coulomb repulsive interaction between ions and the force of the electric field. The sprayed droplets are attracted to the counter electrode by the force of the electric field and attach to the object.

This PTL 1 discloses a configuration using a control electrode formed into a ring shape. The control electrode is disposed at an intermediate position between a nozzle electrode and a stage functioning as the counter electrode to control the spray range of this liquid to be sprayed. PTL 1 explains that raising an electric potential of the control electrode ensures decreasing a diffusion diameter of the liquid to be sprayed, and lowering the electric potential of the control electrode ensures enlarging the diffusion diameter of the liquid to be sprayed.

### CITATION LIST

### Patent Literature

PTL 1: Japanese Unexamined Patent Application Publication No. 8-153669

### SUMMARY OF INVENTION

### Technical Problem

Generally, work to apply liquid while moving a nozzle with respect to a coated object is performed for application of the liquid such as a coating material. Accordingly, to use an electrostatic spray device disclosed in PTL 1 for the application of the liquid such as the coating material, a control electrode also needs to be moved according to the movement of the nozzle. This makes the configuration of the device complicated. Moreover, positioning the control electrode between the nozzle and the coated object causes a problem of hindering the work.

The present invention has been made in consideration of such circumstances, and an object is to provide an electrostatic spray device that ensures a spray state of sprayed atomized liquid in a predetermined state while achieving a compact configuration without hindering a movement of a nozzle and a similar operation.

### Solution to Problem

The present invention is achievable, for example, as the following aspects.

(1) An electrostatic spray device according to one embodiment of the present invention includes a liquid spray unit, voltage application unit, and an isoelectric line adjustment electrode. The liquid spray unit includes a nozzle. The voltage application unit is configured to apply a voltage between the liquid spray unit and a heteropolar portion to generate an electrostatic force causing a liquid to separate from a distal end of the nozzle in a charging state. The heteropolar portion functions as a pole opposite from a pole of the liquid spray unit. The isoelectric line adjustment electrode is configured to adjust equipotential curves. The equipotential curves appear so as to surround the nozzle by the application of the voltage by the voltage application unit. The isoelectric line adjustment electrode is made from a conductive material. The isoelectric line adjustment electrode is configured to obtain the equipotential curves at least partially drawing curvature gentler than curvature of equipotential curves, which appear near a front side of the nozzle in a state where the isoelectric line adjustment electrode is not disposed, on a plane including a center axis of the nozzle. The isoelectric line adjustment electrode is configured to be locatable near an outer periphery at the distal end of the nozzle and to have an electric potential identical to an electric potential of the liquid spray unit such that the equipotential curves drawing the gentle curvature are obtained.

(2) In the above-described configuration (1), the isoelectric line adjustment electrode is mounted to the liquid spray unit.

(3) In the above-described configuration (1) or (2), a position of the isoelectric line adjustment electrode is changeable along the nozzle.

(4) In any one of the above-described configurations (1) to (3), the isoelectric line adjustment electrode is configured such a manner that the equipotential curves all of which draw the curvature gentler than the equipotential curves appearing on the front side of the nozzle in the state where the isoelectric line adjustment electrode is not disposed are obtained.

(5) In the above-described configuration (4), the isoelectric line adjustment electrode is located such that a distal end portion of the isoelectric line adjustment electrode is positioned rearward with respect to the distal end of the nozzle.

(6) In the above-described configuration (5), the distal end portion of the isoelectric line adjustment electrode is formed into a planar shape or formed into a shape inclined toward a rear side radially outward from the nozzle side so as to prevent the equipotential curves appearing between the distal end portion of the isoelectric line adjustment electrode and the nozzle from curving rearward with respect to the distal end portion of the isoelectric line adjustment electrode.

(7) In any one of the above-described configurations (4) to (6), when one axis perpendicular to the center axis of the nozzle is an X-axis and an axis perpendicular to both of the center axis of the nozzle and the X-axis is a Y-axis, the isoelectric line adjustment electrode is configured to adjust the equipotential curves such that one equipotential curves of the equipotential curves appearing on the front side of the nozzle on a cross-sectional surface along the center axis of the nozzle and the Y-axis and the equipotential curves appearing on the front side of the nozzle on a cross-sectional surface along the center axis of the nozzle and the X-axis draw curvature gentler than the other equipotential curves.

(8) In the above-described configuration (1) or (7), when the center axis of the nozzle is a Z-axis, a position of the isoelectric line adjustment electrode is adjustable in a rotation direction around the Z-axis.

(9) Any one of the above-described (1) to (8) further includes at least one or more of isoelectric line adjustment electrodes for exchange configured to form equipotential curves drawing gentle curvature different from the equipotential curves drawn by the isoelectric line adjustment electrode. A state of the curves of the equipotential curves is changeable by exchanging the isoelectric line adjustment electrode.

(10) In any one of the above-described configurations (1) to (9), a coated object functions as the heteropolar portion.

According to one embodiment of the present invention, an electrostatic spray device that ensures a spray state of sprayed atomized liquid in a predetermined state while achieving a compact configuration without hindering a movement of a nozzle and a similar operation can be provided.

### BRIEF DESCRIPTION OF DRAWINGS

FIG. 1 is a cross-sectional view illustrating an overall configuration of an electrostatic spray device of a first embodiment according to the present invention.

FIG. 2 is an exploded cross-sectional view illustrating a liquid spray unit and an isoelectric line adjustment electrode of the first embodiment.

FIG. 3A is a partially enlarged cross-sectional view enlarging a distal end side of the liquid spray unit of the first embodiment when a distal end surface of a central rod is positioned rearward.

FIG. 3B is a partially enlarged cross-sectional view enlarging the distal end side of the liquid spray unit of the first embodiment when the distal end surface of the central rod is positioned forward with respect to the state of FIG. 3A.

FIG. 4 is a perspective view illustrating the liquid spray unit of the first embodiment.

FIG. 5 is a drawing illustrating equipotential curves when a voltage is applied without the isoelectric line adjustment electrode in the electrostatic spray device of the first embodiment.

FIG. 6 is a drawing illustrating the liquid spray unit when the liquid is sprayed without the isoelectric line adjustment electrode in the electrostatic spray device of the first embodiment.

FIG. 7 is a drawing illustrating the equipotential curves when a voltage is applied with the isoelectric line adjustment electrode disposed, in the electrostatic spray device of the first embodiment.

FIG. 8 is a drawing illustrating the liquid spray unit when the liquid is sprayed with the isoelectric line adjustment electrode disposed, in the electrostatic spray device of the first embodiment.

FIG. 9 is a drawing explaining a modification of the isoelectric line adjustment electrode of the first embodiment.

FIG. 10 is a perspective view illustrating a liquid spray unit of an electrostatic spray device of a second embodiment according to the present invention.

FIG. 11A is a drawing illustrating equipotential curves when a voltage is applied to the electrostatic spray device of the second embodiment and illustrates the equipotential curves on a cross-sectional surface along a Z-axis and a Y-axis.

FIG. 11B is a drawing illustrating the equipotential curves when a voltage is applied to the electrostatic spray device of the second embodiment and illustrates the equipotential curves on a cross-sectional surface along the Z-axis and an X-axis.

FIG. 12 is a perspective view of a liquid spray unit including an isoelectric line adjustment electrode of a third embodiment according to the present invention.

FIG. 13 is a drawing explaining a spray state of liquid of the third embodiment according to the present invention.

### DESCRIPTION OF EMBODIMENTS

The following explains configurations (hereinafter, embodiments) to embody the present invention in detail with reference to the attached drawings. Like reference numerals designate identical elements throughout the entire explanation of the embodiments. Unless otherwise stated, expressions such as a “distal (end)” and a “front (forward)” represent a spray direction side of liquid in each member and the like and expressions such as a “rear (end)” and a “rear (rearward)” represent a side opposite to the spray direction of the liquid in each member and the like.

### First Embodiment

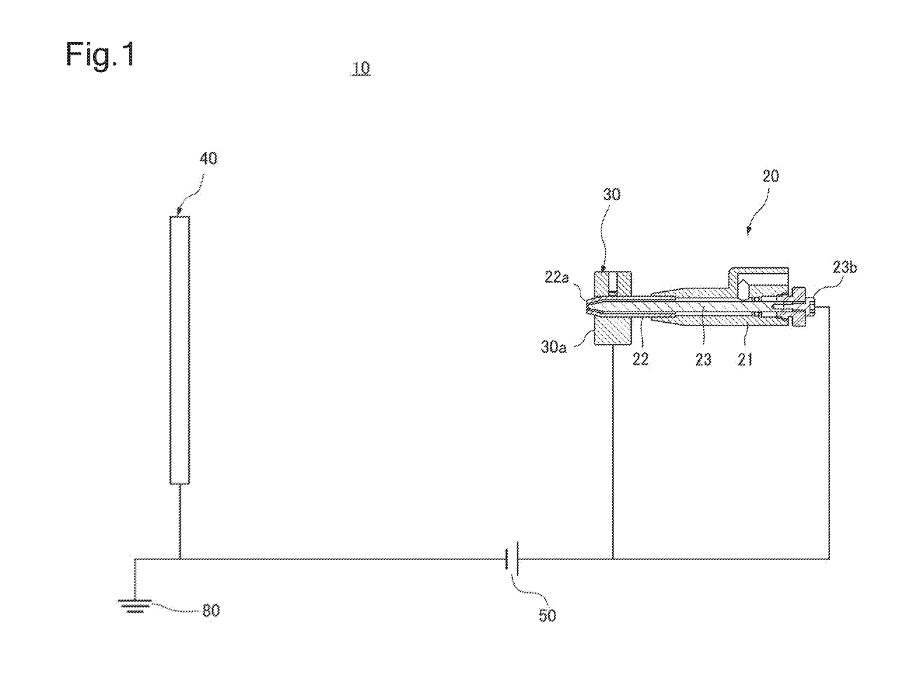

FIG. 1 is a cross-sectional view illustrating an overall configuration of an electrostatic spray device 10 of the first embodiment according to the present invention. As illustrated in FIG. 1, the electrostatic spray device 10 includes a liquid spray unit 20 including a nozzle 22, an isoelectric line adjustment electrode 30, and a voltage application unit (a voltage power supply) 50. The voltage application unit 50 applies a voltage between the liquid spray unit 20 and a heteropolar portion 40 functioning as a pole opposite from a pole of the liquid spray unit 20.

(Liquid Spray Unit)

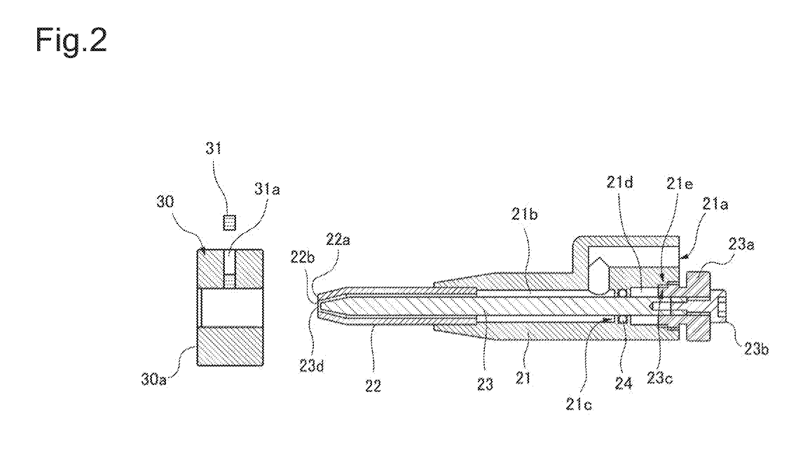

FIG. 2 is an exploded cross-sectional view disassembling the liquid spray unit 20 and the isoelectric line adjustment electrode 30. As illustrated in FIG. 2, the liquid spray unit 20 includes a body 21, the nozzle 22, and a central rod 23. The body 21 is made from an insulating material, and a liquid flow passage 21b is formed inside the body 21. The liquid flow passage 21b includes a liquid supply port 21a from which the liquid is supplied. The nozzle 22 has a through-hole disposed on the distal end of the body 21 so as to communicate with the liquid flow passage 21b in the body 21. The central rod 23 is made from a conductive material and is located inside the liquid flow passage 21b in the body 21 and inside the through-hole on the nozzle 22.

The body 21 has a hole portion 21c communicated with the liquid flow passage 21b to take out the central rod 23 to the rear end side. A sealing member 24 for sealing a clearance with the central rod 23 to prevent a leakage of the liquid is provided in the hole portion 21c. While this embodiment uses an O-ring as the sealing member 24, the sealing member 24 is not limited to the O-ring but any member that can perform the sealing is usable.

A knob portion 23a made from an insulating material and an electrical wiring connecting portion 23b made from a conductive material are disposed at the rear end of the central rod 23 positioned on the rear end side of the body 21. The electrical wiring connecting portion 23b is disposed so as to penetrate an approximately center of the knob portion 23a.

As illustrated in FIG. 1, an electrical wiring from the voltage application unit 50 is coupled to the electrical wiring connecting portion 23b. As illustrated in FIG. 2, locating the electrical wiring connecting portion 23b so as to contact the central rod 23 electrically connects the central rod 23 to the electrical wiring connecting portion 23b.

Additionally, a female screw structure 21e for threaded connection of the knob portion 23a is provided on an inner peripheral surface of a rear end opening 21d of the body 21. Meanwhile, a male screw structure 23c is provided on an outer peripheral surface at the distal end of the knob portion 23a.

Accordingly, by a threaded engagement of the male screw structure 23c on the outer peripheral surface at the distal end of the knob portion 23a with the female screw structure 21e on the rear end opening 21d of the body 21, the central rod 23 is removably mounted to the body 21. Further, adjusting an amount of screwing of the knob portion 23a allows the central rod 23 to be moved in the front-rear direction, thereby ensuring adjusting a position of a distal end surface 23d of the central rod 23 in the front-rear direction.

Here, generally, a nozzle of an electrostatic spray device spraying liquid includes a fine liquid flow passage having a small-diameter through-hole through which the liquid flows. This is inferred because the large opening diameter of the distal end of the nozzle from which the liquid flows out possibly fails to obtain a stable atomization state of the liquid. For example, the opening diameter of the distal end of the nozzle is generally less than 0.1 mm.

In view of this, for example, when the liquid dries, the opening at the distal end of the nozzle immediately clogs. There is a problem that solving this clogging is difficult due to the reduced opening diameter.

However, although the reason will be explained later, the inventors of the present application have been found that the use of the central rod 23 ensures good atomization even when the opening diameter of the distal end of the nozzle is large compared with the conventional one. This allows the opening diameter of an opening 22b at the distal end of the nozzle 22 of this embodiment to be large (for example, 0.2 mm). Consequently, a frequency of a clogging can be significantly lowered.

The opening diameter of the opening 22b of the nozzle 22 is not limited to 0.2 mm but the opening diameter may be around 1 mm in the configuration using the central rod 23.

The opening diameter of the opening 22b of the nozzle 22 is 0.1 mm or more in one embodiment, 0.2 mm or more in another embodiment, and larger than 0.2 mm in yet another embodiment. The clogging is less likely to occur in these embodiments and even if the clogging occurs, cleaning can be performed.

Meanwhile, the opening diameter of the opening 22b of the nozzle 22 is 1.0 mm or less in one embodiment, 0.8 mm or less in another embodiment, and 0.5 mm or less in yet another embodiment. These embodiments can stabilize the atomization.

In this embodiment, the central rod 23 can be moved in the front-rear direction as described above. In view of this, even if the clogging occurs, moving the central rod 23 ensures solving the clogging. Furthermore, the inner diameter of the through-hole of the nozzle 22 is large to the extent that the central rod 23 can be disposed therein. This allows removing and washing the central rod 23 by flowing a large amount of cleaning fluid.

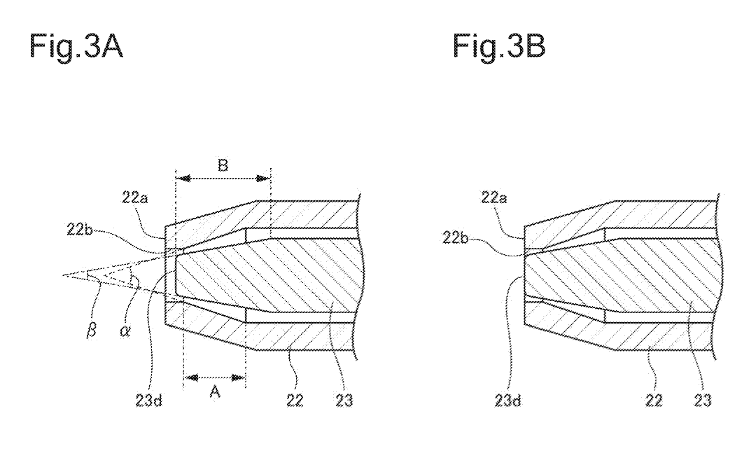

FIG. 3A and FIG. 3B are enlarged views enlarging the distal end side of the liquid spray unit 20. FIG. 3A illustrates the case where the distal end surface 23d of the central rod 23 is positioned rearward. FIG. 3B illustrates the case where the distal end surface 23d of the central rod 23 is positioned forward with respect to the state of FIG. 3A.

As illustrated in FIG. 3A, the nozzle 22 has a tapered inner diameter portion (see a range A) whose inner diameter decreases into a tapered shape toward the opening 22b side. The taper angle of this tapered inner diameter portion is α. The central rod 23 has a tapered portion (see a range B) whose outer diameter decreases toward the distal end surface 23d. The taper angle of the tapered portion is β.

The taper angle α of the tapered inner diameter portion of the nozzle 22 is larger than the taper angle β of the tapered portion of the central rod 23. The distal end surface 23d of the central rod 23 has the diameter smaller than the opening diameter of the opening 22b of the nozzle 22. The tapered portion of the central rod 23 is formed so as to have the diameter gradually enlarging toward the rear end side and have a part with the diameter larger than the opening diameter of the opening 22b of the nozzle 22.

As described above, by forming the distal end sides of the nozzle 22 and the central rod 23, as is apparent from a comparison between FIG. 3A and FIG. 3B, moving the central rod 23 in the front-rear direction allows an adjustment of a width of a clearance formed between the nozzle 22 and the central rod 23. Consequently, the amount of liquid coming out from the opening 22b of the nozzle 22 is adjustable.

The additional movement of the central rod 23 to the front side with respect to the state illustrated in FIG. 3B causes the central rod 23 to abut on the inner peripheral surface of the nozzle 22, thus ensuring blocking the opening 22b of the nozzle 22. Accordingly, blocking the opening 22b of the nozzle 22 with the central rod 23 while the liquid is not sprayed ensures preventing the liquid inside the nozzle 22 from drying. Consequently, the clogging of the nozzle 22 can be reduced.

(Isoelectric Line Adjustment Electrode)

As illustrated in FIG. 2, the isoelectric line adjustment electrode 30 has a screw hole 31a where a female screw structure is provided. After the isoelectric line adjustment electrode 30 is mounted on the nozzle 22 of the liquid spray unit 20, a fixation screw 31 is screwed into the screw hole 31a on the isoelectric line adjustment electrode 30 and the fixation screw 31 is fastened so as to press the outer periphery of the nozzle 22, thus securing the isoelectric line adjustment electrode 30 to the nozzle 22.

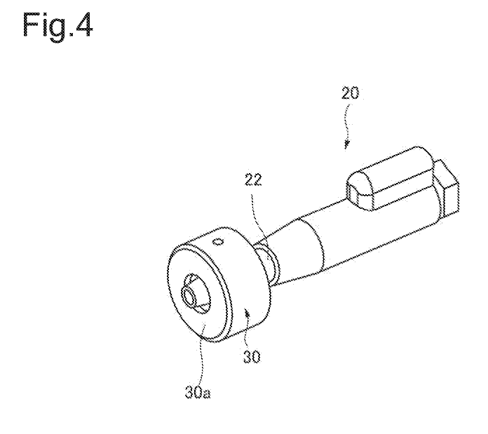

Thus, as illustrated in FIG. 4, the isoelectric line adjustment electrode 30 is mounted so as to be located near the outer periphery at the distal end of the nozzle 22 of the liquid spray unit 20. More specifically, in this embodiment, as illustrated in FIG. 1, the isoelectric line adjustment electrode 30 is secured to the outer periphery of the nozzle 22 so as to be located rearward with respect to a distal end outer peripheral edge 22a of the nozzle 22.

As described above, since the isoelectric line adjustment electrode 30 is secured with the fixation screw 31, loosening the fixation screw 31 ensures the movement of the isoelectric line adjustment electrode 30 so as to run along the nozzle 22. In view of this, the position of the isoelectric line adjustment electrode 30 is adjustable in the front-rear direction along the nozzle 22.

While the isoelectric line adjustment electrode 30 is secured to the nozzle 22 in this embodiment, the isoelectric line adjustment electrode 30 may be secured to the body 21 of the liquid spray unit 20. In this case, the isoelectric line adjustment electrode 30 may be located near the outer periphery at the distal end of the nozzle 22 by an arm structure or a similar structure.

The isoelectric line adjustment electrode 30 is made from a conductive material. As illustrated in FIG. 1, an electrical wiring branched from the electrical wiring coupling the voltage application unit 50 and the electrical wiring connecting portion 23b is coupled to the isoelectric line adjustment electrode 30. Accordingly, the isoelectric line adjustment electrode 30 has an electric potential identical to that of the liquid spray unit 20 (the central rod 23 in this example).

(Heteropolar Portion 40)

This embodiment uses a coated object as the heteropolar portion 40. The electrical wiring is coupled to the coated object on the side opposite to the side coupled to the central rod 23, and this causes the coated object itself to function as a pole opposite from a pole of the liquid spray unit 20. The coated object functioning as the heteropolar portion 40 is grounded by a grounding portion 80. Although not essential, this grounding portion 80 is provided in terms of safety because a worker possibly touches the coated object.

To cause the coated object to function as the heteropolar portion 40, this embodiment couples the electrical wiring from the voltage application unit 50 to the coated object. Note that it is not necessary to directly couple the electrical wiring to the coated object to cause the coated object to function as the heteropolar portion 40.

For example, in the case where the coated object is conveyed to a position at which liquid such as a coating material is applied by a conveying device or a similar device, the coated object may be electrically connected to the voltage application unit 50 via a placing portion of the conveying device on which the coated object is placed, such that the electrical wiring from the voltage application unit 50 is coupled to the placing portion.

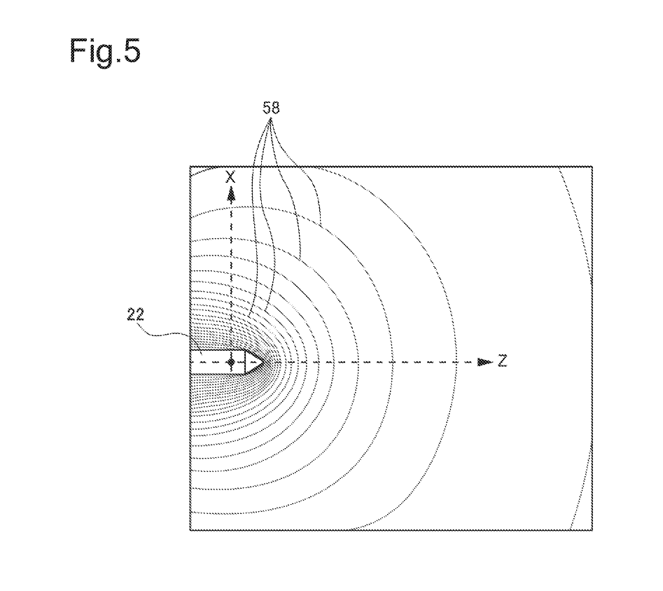

Next, the following further explains the configuration of the electrostatic spray device 10 of the first embodiment and the like in detail while explaining the state of spraying the liquid using the electrostatic spray device 10 of the first embodiment having the configuration as described above. FIG. 5 is a side view illustrating only the distal end side of the nozzle 22 spraying the liquid in the state without the isoelectric line adjustment electrode 30.

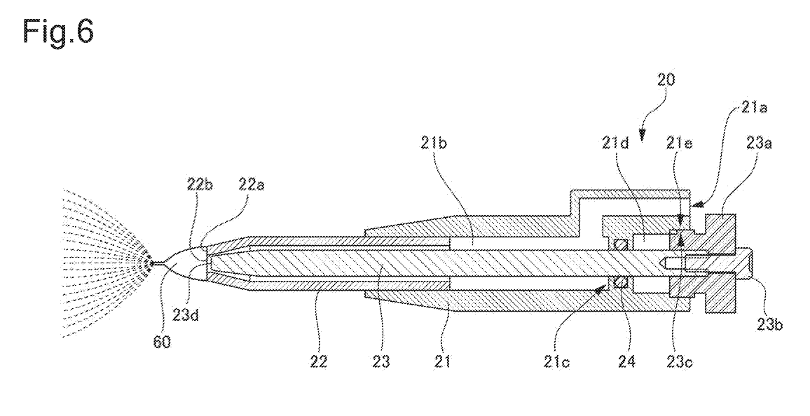

FIG. 5 illustrates a center axis of the nozzle 22 as a Z-axis and illustrates one axis perpendicular to this Z-axis as an X-axis. FIG. 5 also illustrates equipotential curves 58, which appear on a cross-sectional surface along the Z-axis and the X-axis when a voltage is applied. That is, FIG. 5 illustrates the equipotential curves 58 on the plane including the center axis of the nozzle 22. FIG. 6 illustrates the state of spraying the liquid from the liquid spray unit 20 without the isoelectric line adjustment electrode 30.

As illustrated in FIG. 5, applying the voltage causes the equipotential curves 58 to appear so as to surround the nozzle 22. The liquid coming out from the nozzle 22 is drawn in a direction perpendicular to tangents of the equipotential curves 58 by electrostatic force. At this time, the electrostatic force drawing the liquid is balanced with surface tension to the distal end surface 23d of the central rod 23 and the distal end outer peripheral edge 22a of the nozzle 22 and an adhesive force by viscosity. This forms the liquid supplied to the distal end side of the nozzle 22 into a conical shape (in other words, the liquid is in a state of a taylor cone 60) at the distal end as illustrated in FIG. 6.

An action of an electric field causes a separation of positive/negative electric charges in the liquid and a meniscus at the distal end of the nozzle 22 charged by excess charge deforms, thus forming this taylor cone 60 into the conical shape. The liquid is drawn straight from the distal end of the taylor cone 60 by the electrostatic force and then causes an electrostatic explosion.

An attracting force to the front side until this electrostatic explosion occurs becomes an inertia force of the liquid to be sprayed. Furthermore, as a result of an interaction of an expansion force (a repulsion force), the attracting force by the electrostatic force in the direction perpendicular to the tangents of the equipotential curves 58, and the like during the electrostatic explosion, the liquid is sprayed to the front side.

Since this liquid to be sprayed, that is, the liquid separated from the nozzle 22 and becoming liquid particles dramatically increases an area in contact with the air compared with the area in the state before the separation, evaporation of solvent is promoted. A distance between electrons charged in association with the evaporation of the solvent becomes close, electrostatic repulsion (the electrostatic explosion) occurs, and the liquid is divided into the liquid particles with a small grain diameter. When this division occurs, the surface area in contact with the air further increases compared with the surface area before the division; therefore, the evaporation of the solvent is promoted. In view of this, the liquid again causes the electrostatic explosion and is divided into the liquid particles with the small grain diameter, and repetition of such an electrostatic explosion causes the liquid to be atomized.

The liquid may be sequentially supplied by the amount lost from the liquid spray unit 20 through consumption by the spraying, and performing pressure feeding of the liquid at a pressure at which the liquid is injected from the opening 22b of the nozzle 22 (more accurately, the clearance between the opening 22b and the central rod 23) is unnecessary. In the state where the liquid is swiftly injected, the atomization may not be performed on the contrary.

Here, the central rod 23 is disposed inside the nozzle 22 in this embodiment. Assuming that this central rod 23 is not disposed like the conventional electrostatic spray device, the part to which the liquid is attachable is only the distal end outer peripheral edge 22a of the nozzle 22.

In view of this, it is inferred that enlarging the opening diameter of the opening 22b of the nozzle 22 in such state fails to stably atomize the liquid. The reason is considered that, for example, the liquid is likely to swing to the upper, the lower, the right, and the left of the nozzle 22; therefore, the fair taylor cone 60 cannot be formed or the taylor cone 60 itself cannot be maintained. Such phenomenon fails to obtain stability (stability of the size and the number of particles, the charging state, and the like) of the liquid particles separated from the nozzle 22.

Meanwhile, this embodiment locates the central rod 23 inside the nozzle 22; therefore, the liquid also attaches to the distal end surface 23d of the central rod 23 in addition to the distal end outer peripheral edge 22a of the nozzle 22. In other words, the distal end surface 23d of the central rod 23 to which the liquid is attachable is present at the center of the opening 22b. Accordingly, it is considered that even with the large opening diameter of the opening 22b of the nozzle 22, the stable taylor cone 60 can be formed, thereby ensuring the stable atomization of the liquid.

When the distal end surface 23d of the central rod 23 excessively protrudes forward from the distal end outer peripheral edge 22a (namely, the distal end surface of the opening 22b of the nozzle 22) of the nozzle 22, the electric field is less likely to act on the liquid coming out from the nozzle 22. Meanwhile, when the distal end surface 23d of the central rod 23 excessively recedes rearward from the distal end surface of the opening 22b of the nozzle 22, this results in a state equivalent to a state in which the part to which the liquid is attachable is absent at the center of the opening 22b.

Accordingly, in one embodiment, in the state of spraying the liquid, the distal end surface 23d of the central rod 23 is positioned within a range ten times the opening diameter of the opening 22b at the distal end of the nozzle 22 in the front-rear direction along the center axis of the central rod 23 with respect to the distal end surface of the opening 22b of the nozzle 22. In another embodiment, the distal end surface 23d of the central rod 23 is positioned within a range five times the opening diameter of the opening 22b, and in yet another embodiment, the distal end surface 23d is positioned within a range three times the opening diameter.

For example, in this embodiment, the opening 22b of the nozzle 22 has the opening diameter of 0.2 mm, and when the electrostatic force is not taken into consideration, the liquid coming out from the opening 22b of the nozzle 22 comes out so as to have a hemispherical shape with the diameter of about 0.2 mm at the distal end of the nozzle 22.

In one embodiment, the distal end of the central rod 23 is present near this liquid such that the electric field (the electrostatic force) acts on the liquid coming out to the distal end of the nozzle 22 to ensure the formation of the conical-shaped taylor cone 60. In one embodiment, the distal end of the central rod 23 is positioned within 2 mm forward (the direction in which the liquid comes out) from the distal end surface of the opening 22b of the nozzle 22. Meanwhile, in one embodiment, the distal end of the central rod 23 is positioned within 2 mm rearward (the receding direction) from the distal end surface of the opening 22b of the nozzle 22 such that the liquid is attachable.

As described above, providing the central rod 23 ensures the stable atomization of the liquid even when the opening diameter of the opening 22b of the nozzle 22 is enlarged. In view of this, the opening diameter of the opening 22b of the nozzle 22 can be a large opening diameter by which the clogging can be suppressed. The opening diameter of the opening 22b of the nozzle 22 can be enlarged, thereby ensuring manufacturing the nozzle 22 through machining.

This embodiment describes the case where the distal end of the central rod 23 has the flat plane as the distal end surface 23d. Note that the distal end of the central rod 23 always needs not to have the flat plane. For contribution to the formation of the stable taylor cone 60, for example, the distal end of the central rod 23 may have a curved surface projecting toward the front side such as a rounded shape.

As is apparent from FIG. 5, the equipotential curves 58, which appear so as to surround the nozzle 22 by the application of the voltage, appear so as to draw circles around the nozzle 22. Considering that when tangents are drawn on these equipotential curves 58, the attracting force of the electrostatic force works in the direction perpendicular to these tangents, various directions are possibly present as the direction perpendicular to the tangents of the equipotential curves 58 based on the separating liquid, such as an oblique direction and a lateral direction, in addition to the forward direction. In view of this, the separating liquid receives the tension by the electrostatic force in the various directions. Accordingly, the liquid is sprayed in a wide range on the front side according to the balance of this electrostatic force, the inertia force, the electrostatic explosion force (the repulsion force), and the like.

Therefore, this embodiment includes the isoelectric line adjustment electrode 30 to match a state of the equipotential curves 58 to the expansion state of the liquid according to the application of the liquid. This isoelectric line adjustment electrode 30 is made from the conductive material for adjusting the state of the equipotential curves 58, and has the electric potential identical to the liquid spray unit 20 (the central rod 23 in this example).

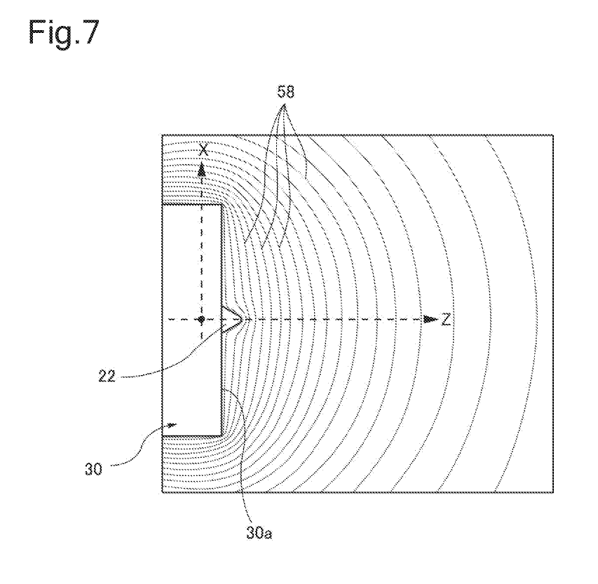

While FIG. 7 is a side view illustrating only the distal end side of the nozzle 22 spraying the liquid similar to FIG. 5, the isoelectric line adjustment electrode 30 is additionally provided. FIG. 7 also illustrates the equipotential curves 58 in the state. The Z-axis and the X-axis of FIG. 7 are similar to those illustrated in FIG. 5. That is, FIG. 7 also illustrates the equipotential curves 58 on the plane including the center axis of the nozzle 22.

As is apparent from FIG. 7, it is understood that providing the isoelectric line adjustment electrode 30 produces the equipotential curves 58 drawing curvature gentler than that of the equipotential curves 58 on the plane including the center axis of the nozzle 22, which the equipotential curves 58 appears near the front side of the nozzle 22 in the state illustrated in FIG. 5 where the isoelectric line adjustment electrode 30 is not provided. That is, it is understood that the equipotential curves 58 illustrated in FIG. 7 are close to the state of the equipotential curves 58 being aligned parallel to each other forward. Note that “near the front side of the nozzle 22” is in a range which does not exceed a range of a column-shaped space with a diameter within about 150 mm or within about 100 mm and a height within about 150 mm or within about 100 mm extending forward from the distal end of the nozzle 22. The diameter of the column-shaped space is a diameter of a circle perpendicular to the center axis of the nozzle 22, and the height of the column-shaped space is a length in the direction of the center axis of the nozzle 22.

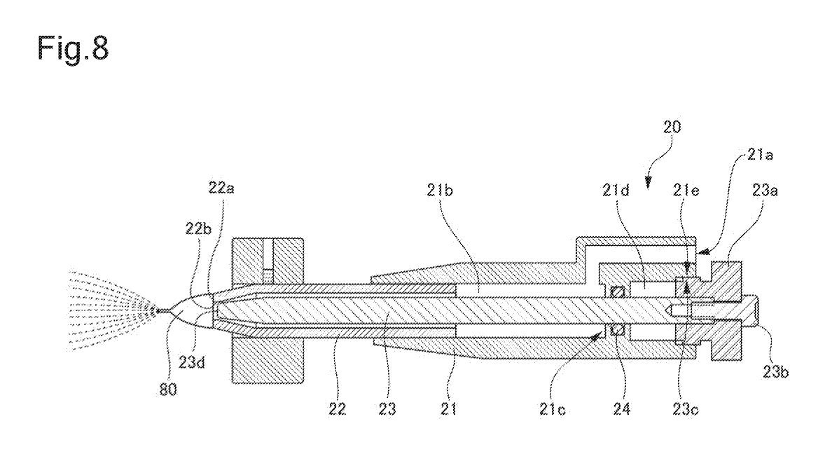

When the equipotential curves 58 become the state illustrated in FIG. 7, the direction based on the separating liquid, which direction is perpendicular to the tangents of the equipotential curves 58, mainly becomes the forward direction. In view of this, although the liquid expands due to the electrostatic explosion during and after the separation of the liquid and the like, the liquid is less likely to expand compared with the state without the isoelectric line adjustment electrode 30. Consequently, as illustrated in FIG. 8, the liquid to be sprayed is sprayed while not expanding too much.

Locating the isoelectric line adjustment electrode 30 at a position excessively separated rearward from the nozzle 22 deteriorates the action to adjust the equipotential curves 58. In view of this, the isoelectric line adjustment electrode 30 is located near the outer periphery at the distal end of the nozzle 22 such that the equipotential curves 58 draw the curvature gentler than that of the equipotential curves 58 appearing on the front side of the nozzle 22 when the isoelectric line adjustment electrode 30 is not provided.

FIG. 4 illustrates a perspective view of the liquid spray unit 20. As illustrated in FIG. 4, this embodiment configures a distal end portion 30a of the isoelectric line adjustment electrode 30 into the plane. By this configuration, the equipotential curves 58 appearing between the distal end portion 30a of the isoelectric line adjustment electrode 30 and the nozzle 22 do not curve to the rear side with respect to the distal end portion 30a of the isoelectric line adjustment electrode 30 as illustrated in FIG. 7.

For example, it is considered that the use of a tubular isoelectric line adjustment electrode opening to the forward without this planar part of the distal end portion 30a of the isoelectric line adjustment electrode 30 easily concaves the equipotential curves 58 to the rear side near the nozzle 22.

This causes a steep change of the equipotential curves 58 near the nozzle 22. Accordingly, although it is considered that this is also depending on the position of the separation point at which the liquid separates by the electrostatic explosion, this configuration possibly makes the effect to reduce the expansion of the liquid unstable.

Therefore, like this embodiment, the equipotential curves 58 may be set such that the equipotential curves 58 appearing between the distal end portion 30a of the isoelectric line adjustment electrode 30 and the nozzle 22 do not curve to the rear side with respect to the distal end portion 30a of the isoelectric line adjustment electrode 30.

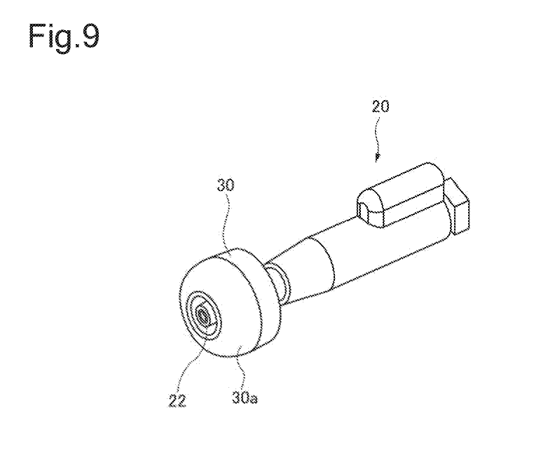

It is inferred that when the isoelectric line adjustment electrode 30 is formed into a shape inclining to the rear side from the nozzle 22 side outward like the isoelectric line adjustment electrode 30 of the first embodiment illustrated in FIG. 9, the equipotential curves 58 producing a steep hollow do not appear. Accordingly, similarly to the isoelectric line adjustment electrode 30 illustrated in FIG. 4, the equipotential curves 58 with a decreased steep change near the nozzle 22 can be formed.

Meanwhile, to what extent the equipotential curves 58 appearing on the front side of the nozzle 22 produce the gentle curve state, that is, to what extent the equipotential curves 58 become close to the state of being aligned parallel to each other forward changes depending on the position of the isoelectric line adjustment electrode 30 in the front-rear direction and the size thereof.

In view of this, for example, in one embodiment, the isoelectric line adjustment electrode 30 is configured such that the position thereof can be changed along the nozzle 22 to obtain the appropriate expansion of the liquid required for the application of the liquid. To form the equipotential curves 58 drawing different gentle curvature, at least one or more of the isoelectric line adjustment electrodes 30 for exchange including the distal end portion 30a whose size is changed may be prepared. In this case, exchanging the isoelectric line adjustment electrode 30 allows changing a state of the curvature of the equipotential curves 58.

Different from a conventional converging guard ring, the isoelectric line adjustment electrode 30 having the configuration as described above needs not to be located between a target and the nozzle 22 and further can be located near the outer periphery at the distal end of the nozzle 22. In view of this, the isoelectric line adjustment electrode 30 can be mounted to the liquid spray unit 20. Additionally, when the liquid spray unit 20 is moved to apply the liquid over the coated object, the electric potential line adjustment electrode 30 can be moved together with the liquid spray unit 20 without a complicated construction. Since the electric potential line adjustment electrode 30 is not positioned between the coated object and the liquid spray unit 20, the electric potential line adjustment electrode 30 does not hinder the work.

### Second Embodiment

Next, the following explains an electrostatic spray device 10 of the second embodiment according to the present invention. The second embodiment differs from the first embodiment in that the electrostatic spray device 10 includes the isoelectric line adjustment electrode 30 that can form the spray pattern of the liquid into an ellipsoidal shape, and the configurations other than that is similar to those of the first embodiment. The electrostatic spray device 10 is usable for the case where the spray pattern of the liquid is required to have an ellipsoidal shape when the liquid such as the coating material is applied. The following mainly explains this difference and omits the explanations of the similar points in some cases.

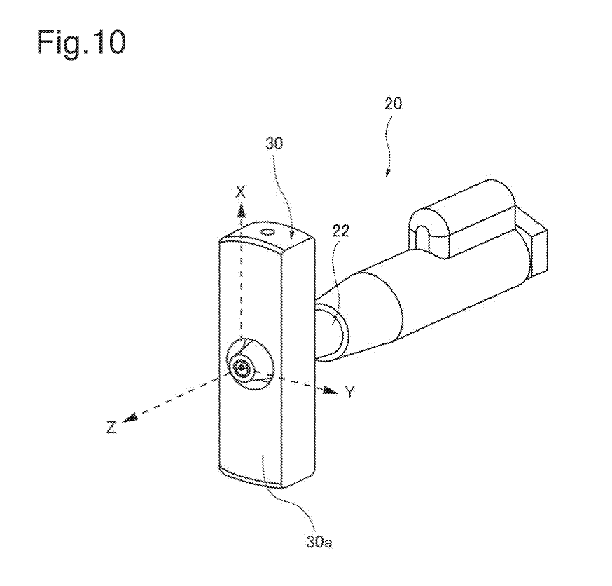

FIG. 10 is a perspective view illustrating the liquid spray unit 20 of the electrostatic spray device 10 of the second embodiment. Similarly to FIG. 5, FIG. 10 illustrates the center axis of the nozzle 22 as the Z-axis, illustrates one axis perpendicular to this Z-axis as the X-axis, and further illustrates an axis perpendicular to both of these Z-axis and X-axis as a Y-axis.

As illustrated in FIG. 10, the isoelectric line adjustment electrode 30 of the second embodiment has a width of the plane of the distal end portion 30a in the Y-axis direction narrower than a width of the plane of the distal end portion 30a in the X-axis direction.

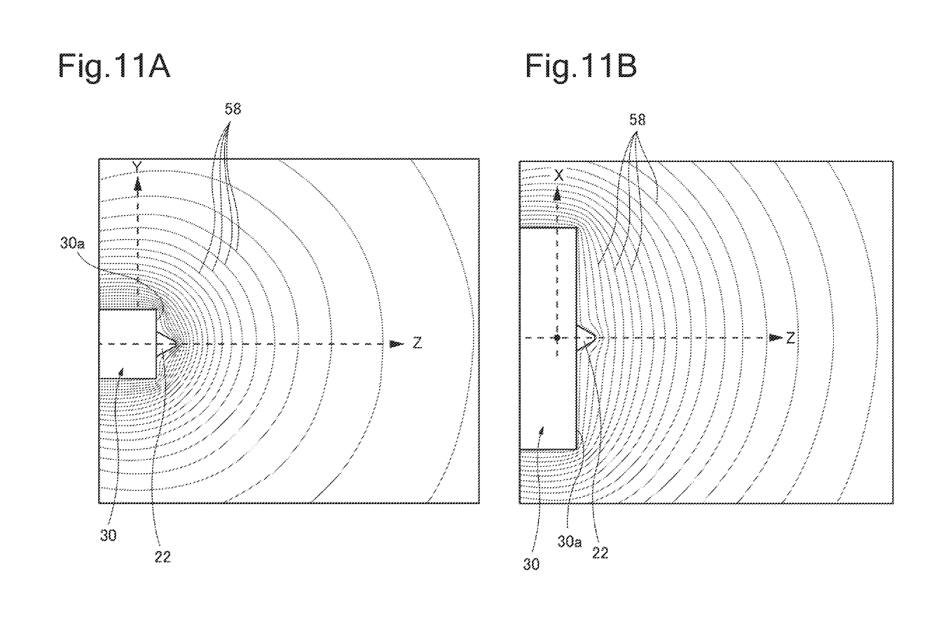

FIG. 11A and FIG. 11B are side views near the distal end of the nozzle 22, and FIG. 11A is a side view as viewed in the Y-axis direction. FIG. 11B is a side view as viewed in the X-axis direction.

FIG. 11A also illustrates the equipotential curves 58, which appear on a cross-sectional surface along the Z-axis and the Y-axis when a voltage is applied. FIG. 11B also illustrates the equipotential curves 58, which appear on a cross-sectional surface along the Z-axis and the X-axis when a voltage is applied.

As is apparent from a comparison between FIG. 11A and FIG. 11B, in FIG. 11B, the equipotential curves 58 appearing when the voltage is applied draw the considerably gentle curvature (the equipotential curves 58 are close to parallel) compared with the case where the isoelectric line adjustment electrode 30 is not provided, similarly to the first embodiment.

Meanwhile, in FIG. 11A, although the equipotential curves 58 draw the gentle curvature (the equipotential curves 58 are close to parallel) compared with the case where the isoelectric line adjustment electrode 30 is not provided, the equipotential curves 58 still largely curve.

That is, the isoelectric line adjustment electrode 30 of the second embodiment is configured to adjust the equipotential curves 58 such that one the equipotential curves 58 (the equipotential curves 58 on the cross-sectional surface along the Z-axis and the X-axis in this example) draw the curvature gentler than the other equipotential curves 58 (the equipotential curves 58 on the cross-sectional surface along the Z-axis and the Y-axis in this example), of the equipotential curves 58 appearing on the front side of the nozzle 22 on the cross-sectional surface along the Z-axis and the Y-axis and the equipotential curves 58 appearing on the front side of the nozzle 22 on the cross-sectional surface along the Z-axis and the X-axis.

Accordingly, the expansion of the liquid is small in the X-axis direction illustrated in FIG. 11B. Meanwhile, the expansion of the liquid is large in the Y-axis direction illustrated in FIG. 11A. Consequently, the liquid to be sprayed from the liquid spray unit 20 illustrated in FIG. 10 is sprayed to the front side as the spray pattern with the ellipsoidal shape having a long axis in the Y-axis direction and a short axis in the X-axis direction illustrated in FIG. 10.

Rotating the isoelectric line adjustment electrode 30 illustrated in FIG. 10 by 90° around the Z-axis and narrowing the width of the plane of the distal end portion 30a along the X-axis also sets the ellipsoidal pattern of the liquid to be sprayed into the state rotated by 90°.

Accordingly, as long as the isoelectric line adjustment electrode 30 is configured such that the position of the isoelectric line adjustment electrode 30 can be adjusted in the rotation direction around the Z-axis, the direction of the ellipsoidal pattern to be sprayed is changeable in the rotation direction around the Z-axis according to the shape of the surface over which the liquid as the coated object is applied, and the like. In view of this, one embodiment configures the isoelectric line adjustment electrode 30 such that the position of the isoelectric line adjustment electrode 30 in the rotation direction around the Z-axis is adjustable.

### Third Embodiment

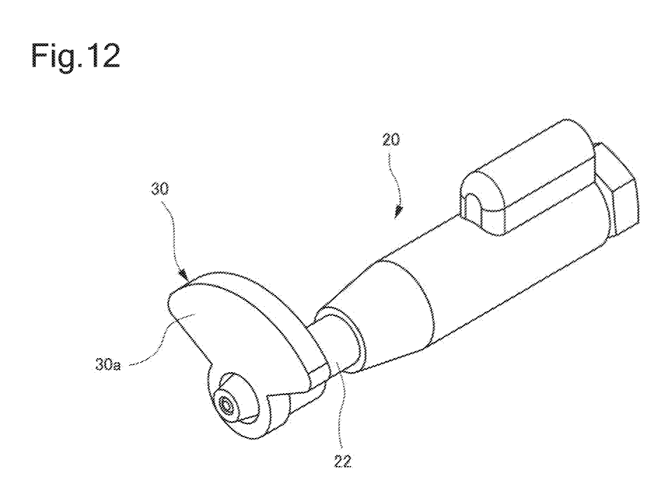

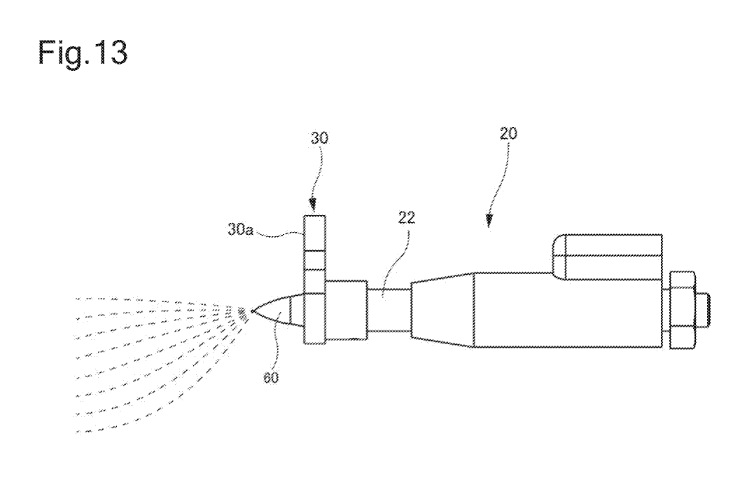

Next, the following explains an electrostatic spray device 10 of the third embodiment with reference to FIG. 12 and FIG. 13.

The basic configuration of the third embodiment is identical to the configurations of the first embodiment and the second embodiment and differs from those of the above-described embodiments only in that the configuration of the isoelectric line adjustment electrode 30 provided to the liquid spray unit 20 differs. Therefore, the following mainly explains the isoelectric line adjustment electrode 30 and omits the explanations of the other parts in some cases.

In the above-explained embodiments, the isoelectric line adjustment electrode 30 is configured such that all of the equipotential curves 58 draw the curvature gentler than the equipotential curves 58 appearing on the front side of the nozzle 22 in the state without the isoelectric line adjustment electrode 30.

Note that all of the equipotential curves 58 do not mean all of the equipotential curves 58 reaching the infinity forward the nozzle 22 but means all of the equipotential curves 58 appearing near the front side of the nozzle 22 in a range mainly affecting the separation direction of the separating liquid when the liquid separates from the nozzle 22.

For example, the isoelectric line adjustment electrode 30 of the first embodiment is configured such that all of the equipotential curves 58 appearing near the front side of the nozzle 22 draw the further gentle curvature in an approximately uniform manner.

Although the isoelectric line adjustment electrode 30 of the second embodiment differs in the extent of drawing the gentle curvature between in the X-axis direction and in the Y-axis direction, the isoelectric line adjustment electrode 30 is configured such that all of the equipotential curves 58 draw the curvature gentler than that in the state before the isoelectric line adjustment electrode 30 is disposed, after all.

However, the isoelectric line adjustment electrode 30 needs not to be limited to the configuration where all of the equipotential curves 58 appearing near the front side of the nozzle 22 draw the further gentle curvature.

For example, as illustrated in FIG. 12, the isoelectric line adjustment electrode 30 may be formed into a fan shape (formed into the fan shape of approximately 120° in this example), and the isoelectric line adjustment electrode 30 may be located such that this fan-shaped electrode part is positioned on the upper side of the nozzle 22. In this case, the equipotential curves 58 (not illustrated) appearing near the front side of the nozzle 22 draw the curvature gentler than those before the isoelectric line adjustment electrode 30 is disposed only in the range of this fan-shaped electrode part.

Meanwhile, in a range in which this fan-shaped electrode part is not positioned, that is, in a range of approximately 240° on the lower side of the nozzle 22, the equipotential curves 58 (not illustrated) appearing near the front side of the nozzle 22 is held in the state almost identical to the state before the isoelectric line adjustment electrode 30 is disposed. While the distal end portion 30a is formed into the plane in this embodiment as well, the distal end portion 30a may be gently inclined rearward.

Then, the part of the equipotential curves 58 (not illustrated) appearing near the front side of the nozzle 22 draw the gentle curvature in the range of approximately 120° on the upper side of the nozzle 22. Therefore, as illustrated in FIG. 13, in the range of about 120° on the upper side of the nozzle 22, the separating liquid does not expand so much and separates toward the front side.

Meanwhile, in the range of approximately 240° on the lower side of the nozzle 22, the equipotential curves 58 (not illustrated) remain to be steeply curved like the state before the isoelectric line adjustment electrode 30 is disposed. In view of this, the separating liquid separates so as to widely expand following the curvature of the equipotential curves 58 (not illustrated).

Thus, the isoelectric line adjustment electrode 30 may be configured such that a part of the equipotential curves 58 draws the curvature gentler than the equipotential curves 58 (not illustrated) appearing near the front side of the nozzle 22 in the state where the isoelectric line adjustment electrode 30 is not disposed.

While the present invention has been explained based on the specific embodiments, the present invention is not limited to the above-described embodiments and may be modified and improved as necessary.

Thus, the present invention is not limited to the specific embodiments, and ones modified and improved as necessary are also encompassed in the technical scope of the present invention, which are apparent for the person skilled in the art from the description of the claims.

### REFERENCE SIGNS LIST

10 electrostatic spray device

20 liquid spray unit

21 body

21a liquid supply port

21b liquid flow passage

21c hole portion

21d rear end opening

22 nozzle

22a distal end outer peripheral edge

22b opening

23 central rod

23a knob portion

23b electrical wiring connecting portion

23c male screw structure

23d distal end surface

24 sealing member

30 isoelectric line adjustment electrode

30a distal end portion

31 fixation screw

31a screw hole

40 heteropolar portion (coated object)

50 voltage application unit

60 taylor cone

80 grounding portion

1. An electrostatic spray device comprising:
a liquid spray unit including a nozzle;
a voltage application unit configured to apply a voltage between the liquid spray unit and a heteropolar portion functioning as a pole opposite from a pole of the liquid spray unit to generate an electrostatic force for causing a liquid to separate from a distal end of the nozzle in a charging state; and
an isoelectric line adjustment electrode made from a conductive material and configured to adjust equipotential curves appearing so as to surround the nozzle by the application of the voltage by the voltage application unit,
wherein the isoelectric line adjustment electrode is configured to obtain an equipotential curves at least partially drawing curvature gentler than curvature of equipotential curves on a plane including a center axis of the nozzle, which equipotential curves appear near a front side of the nozzle in a state where the isoelectric line adjustment electrode is not disposed, and
the isoelectric line adjustment electrode is configured to be locatable near an outer periphery at the distal end of the nozzle and to have an electric potential identical to an electric potential of the liquid spray unit such that the equipotential curves drawing the gentle curvature are obtained.

2. The electrostatic spray device according to claim 1, wherein
the isoelectric line adjustment electrode is mounted to the liquid spray unit.

3. The electrostatic spray device according to claim 1 or claim 2, wherein
a position of the isoelectric line adjustment electrode is changeable along the nozzle.

4. The electrostatic spray device according to claim 1, wherein
the isoelectric line adjustment electrode is configured so as to obtain the equipotential curves all of which draw the curvature gentler than the equipotential curves appearing on the front side of the nozzle in the state where the isoelectric line adjustment electrode is not disposed.

5. The electrostatic spray device according to claim 4, wherein
the isoelectric line adjustment electrode is disposed such that a distal end portion of the isoelectric line adjustment electrode is positioned rearward with respect to the distal end of the nozzle.

6. The electrostatic spray device according to claim 5, wherein
the distal end portion of the isoelectric line adjustment electrode is formed into a planar shape or formed into a shape inclined toward a rear side radially outward from the nozzle side so as to prevent an equipotential curves appearing between the distal end portion of the isoelectric line adjustment electrode and the nozzle from curving toward the rear side with respect to the distal end portion of the isoelectric line adjustment electrode.

7. The electrostatic spray device according to claim 4, wherein
when one axis perpendicular to the center axis of the nozzle is an X-axis and an axis perpendicular to both of the center axis of the nozzle and the X-axis is a Y-axis, the isoelectric line adjustment electrode is configured to adjust the equipotential curves such that one equipotential curves of the equipotential curves appearing on the front side of the nozzle on a cross-sectional surface along the center axis of the nozzle and the Y-axis and the equipotential curves appearing on the front side of the nozzle on a cross-sectional surface along the center axis of the nozzle and the X-axis draw curvature gentler than the other the equipotential curves.

8. The electrostatic spray device according to claim 1, wherein:
when the center axis of the nozzle is a Z-axis, a position of the isoelectric line adjustment electrode is adjustable in a rotation direction around the Z-axis.

9. The electrostatic spray device according to claim 1, further comprising
at least one or more of isoelectric line adjustment electrodes for exchange different from the isoelectric line adjustment electrode, the at least one or more of isoelectric line adjustment electrodes being configured to form equipotential curves drawing gentle curves, wherein
a state of the curvature of the equipotential curves is changeable by exchanging the isoelectric line adjustment electrode for the isoelectric line adjustment electrode for exchange.

10. The electrostatic spray device according to claim 1, wherein
a coated object functions as the heteropolar portion.
